(19) United States
(12) Patent Application Publication
(10) Pub. No.: US 2013/0141407 A1
(43) Pub. Date: Jun. 6, 2013

(54) STEREOSCOPIC DISPLAY SYSTEM USING LIGHT-SOURCE DETECTOR

(71) Applicant: Christopher J. White, Avon, NY (US)

(72) Inventor: Christopher J. White, Avon, NY (US)

(21) Appl. No.: 13/312,075

(22) Filed: Dec. 6, 2011

(51) Int. Cl. G09G 5/00; G02B 27/26; G02B 27/22

(52) U.S. Cl. 345/207; 359/464; 359/465

(57) ABSTRACT

A stereoscopic display system for displaying stereoscopic image data includes an illumination system that provides a temporal sequence of illumination from left-eye and right-eye light sources having different optical properties, and a monochrome reflective display system including a directly-viewable display surface having display pixels with a controllable reflectance. The illumination system is selectively connectable to the display. When the illumination system and display system are connected, the display system synchronously controls the reflectance of the display pixels according to image data for left-eye and right-eye images. When the illumination system and display system are not connected, the display pixels are controlled to display a monoscopic image determined from the stereoscopic image data. The illumination system optionally provides illumination using a plurality of illumination color channels to provide color stereoscopic images.

### CROSS-REFERENCE TO RELATED APPLICATIONS

Reference is made to commonly assigned, co-pending U.S. patent application Ser. No. ______ (Docket K000616), entitled “Color multichannel display system using illumination detector”, by White; to commonly assigned, co-pending U.S. patent application Ser. No. ______ (Docket K000756), entitled “Stereoscopic display system using illumination detector”, by White; and to commonly assigned, co-pending U.S. patent application Ser. No. ______ (Docket K000754, entitled “Stereoscopic display system using illumination detector”, by White, each of which is incorporated herein by reference.

### FIELD OF THE INVENTION

This invention pertains to the field of displays and more particularly to stereoscopic electronic displays.

### BACKGROUND OF THE INVENTION

Portable soft-copy displays are increasing in popularity. Cellular telephones, tablet computers, notebook computers, and other personal electronic devices commonly include displays. Since many of these devices are battery operated, there is a strong motivation to use components, including displays, that consume low power levels in order to extend battery life. However, a tradeoff exists between providing high-quality displays and providing low-power displays. For example, increasing the display luminance or color saturation in order to provide a higher quality level usually requires higher drive power levels, which in turn decreases battery life. Color displays also typically require more power to produce images using three color primaries compared to monochrome displays providing the same luminance level. Likewise, stereoscopic displays generally require more power than monoscopic displays since they need to produce twice as much light to provide both a left-eye image and a right-eye image, each having adequate luminance.

One type of display used in very low-power devices is an “e-paper” display. These displays can include bistable elements that either absorb or reflect light, and that do not require power to maintain their state. These displays use very low power and have acceptable contrast, but generally refresh too slowly to display video, and if they provide color, are very limited in saturation. For example, a Ricoh e-paper display shown in May 2011 had a color gamut of only 27% of the NTSC gamut.

Field-sequential display systems, both reflective and transmissive, have been used. For example, U.S. Patent Application Publication 2006/0197727 to Malzbender, entitled “Increasing brightness in field-sequential color displays,” describes a display panel with pixels that have OFF and ON states and a light source arrangement that emits at least two colors of light. The pixels form images by modulating light in a temporal sequence during an image frame in response to drive signals generated from incoming video data. The image frame is divided into color segments with only one color of light being emitted from the light source during each segment. Similarly, U.S. Patent Application Publication 2010/0091050 to El-Ghoroury et al., entitled “Hierarchical multicolor primaries temporal multiplexing system,” describes field-sequential displays in which the light is provided by solid-state devices such as LEDs. However, these schemes are tightly coupled to sequentially-activated light sources, and are not operational without them. U.S. Pat. No. 7,859,554 to Young, entitled “Apparatus, methods, and systems for multi-primary display or projection,” describes multiple-primary systems but does not overcome this deficiency.

U.S. Patent Application Publication 2010/0188443 to Lewis et al., entitled “Sensor-based feedback for display apparatus,” describes a field-sequential reflective display with MEMS (micro-electro-mechanical system) pixels. Lewis describes monitoring the light output of lamps used with this system, and adjusting to compensate for light-output variations. However, the device of Lewis is still inoperative without a field-sequential light source.

U.S. Patent Application Publication 2006/0176259 to Yamada, entitled “Liquid crystal display device and display control method and program for the liquid crystal display device,” describes adjusting displayed information based on position information of a viewer relative to a liquid crystal panel. Yamada does this to suppress color variation with viewing angle. The position information can be acquired from a camera in a known location with respect to the panel.

U.S. Patent Application Publication 2010/0327764 to Knapp, entitled “Intelligent illumination device,” describes modulating light from a light source to transmit information. This technique is referred to in the art as “visible-light communication” (VLC). Modulations of the visible light are sufficiently rapid or low-amplitude to be invisible to humans, but they are detectable by devices that use photosensors to monitor the light around them.

There remains a need for a high-quality, low-power display for portable electronic devices, and in particular for displays that can provide color or stereoscopic images and are operative under any viewing condition.

### SUMMARY OF THE INVENTION

This need is met by a display system including a directly-viewable display surface and an associated removably-connectable illumination system that includes right-eye and left-eye light sources operated in sequence. Associated with the display is a removably-connectable illumination system with the light sources. When the illumination system is connected to the display system, the display operates as a field-sequential stereoscopic display, wherein the display surface provides reflectance for the appropriate eyes in sync with the activation of the light sources. When the illumination system is not connected to the display system, it operates as a monoscopic display. This advantageously permits the display to be used under various lighting conditions, including conditions in which the illumination system is not connected, or is not activated (e.g., to save power).

Therefore, according to an aspect of the present invention, there is provided a stereoscopic display system for displaying a stereoscopic image having image data for a left-eye image channel and a right-eye image channel, comprising:

a) an illumination system including:
i) a left-eye light source providing light having a first optical property; and
ii) a right-eye light source providing light having a second optical property different from the first optical property; and

b) a monochrome reflective display system removably connectable to the illumination system, the monochrome reflective display system including:
i) a directly-viewable display surface including an array of display pixels, each having a respective controllable reflectance;
ii) a detector for automatically detecting whether or not the illumination system is connected to the display system and providing a corresponding connection signal; and
iii) a system controller that controls the display pixels and the illumination system in response to the connection signal, the display control system adapted to:
   A) in response to the detector detecting that the illumination system is connected to the display system and is active, sequentially activate the left-eye light source and the right-eye light source according to a temporal sequence, and control the reflectance of the display pixels in synchronization with the activation of the light sources according to the image data for the left-eye image channel when the left-eye light source is activated and according to the image data for the right-eye image channel when the right-eye light source is activated; and
   B) in response to the detector detecting that the illumination system is not connected to the display system or is not active, determine monoscopic image data from the image data for the left-eye image channel or the image data for the right-eye image channel and control the reflectance of the display pixels according to the monoscopic image data.

According to another aspect of the present invention, there is provided a stereoscopic color display system for displaying a stereoscopic color image having image data for a plurality of left-eye image color channels and a plurality of right-eye image color channels, the system comprising:

a) an illumination system including:
i) a plurality of left-eye colored light sources, each providing light corresponding to an illumination color primary; and
ii) a plurality of right-eye light sources, each providing light corresponding to an illumination color primary; and

b) a monochrome reflective display system removably connectable to the illumination system, the display system including:
i) a directly-viewable display surface including an array of display pixels, each having a respective controllable reflectance;
ii) a detector for automatically detecting whether or not the illumination system is connected to the display system and providing a corresponding connection signal; and
iii) a system controller that controls the display pixels and the illumination system in response to the connection signal, the system controller adapted to:
   A) in response to the detector detecting that the illumination system is connected to the display system, activate the left-eye and right-eye colored light sources to sequentially provide a plurality of illumination channels corresponding to the left-eye and right-eye image color channels, so that each illumination channel defines a respective active eye and a respective active one of the illumination color channels, and control the reflectance of the display pixels according to the image data for each successive active eye and active one of the illumination color channels; and
   B) in response to the detector detecting that the illumination system is not connected to the display system, determine monoscopic, monochrome image data from the image data for one or more of the left-eye or right-eye image color channels and control the reflectance of the display pixels according to the monoscopic, monochrome image data so that the stereoscopic color display system functions as a monoscopic, monochrome display system.

An advantage of this invention is that the display system can be used to display information whether or not the illumination system is used to provide illumination to the monochrome reflective display system. Various embodiments enable the viewer to choose between a stereoscopic display mode with higher power consumption or a monoscopic display mode with lower power consumption. Various embodiments provide a compact LED light source that can be connected as desired. This provides stereoscopic imagery when desired, and low power consumption at other times. Various embodiments operate without requiring the viewer to wear 3-D glasses.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIGS. 1A-1C show a color display system at successive times;

FIG. 2 shows details of the color display system of FIGS. 1A-1C according to various embodiments;

FIG. 3 shows a display system according to various embodiments;

FIGS. 4A-4D show stereoscopic display systems according to various embodiments;

FIGS. 5A-5B show various embodiments of color stereoscopic display systems;

FIG. 6 shows a block diagram of display systems according to various embodiments; and

FIGS. 7A-7D show various embodiments of stereoscopic display systems.

The attached drawings are for purposes of illustration and are not necessarily to scale.

### DETAILED DESCRIPTION OF THE INVENTION

In the following description, some embodiments will be described in terms that would ordinarily be implemented as software programs. Those skilled in the art will readily recognize that the equivalent of such software can also be constructed in hardware. Because image manipulation algorithms and systems are well known, the present description will be directed in particular to algorithms and systems forming part of, or cooperating more directly with, systems and methods described herein. Other aspects of such algorithms and systems, and hardware or software for producing and otherwise processing the image signals involved therewith, not specifically shown or described herein, are selected from such systems, algorithms, components, and elements known in the art. Given the systems and methods as described herein, software not specifically shown, suggested, or described herein that is useful for implementation of any embodiment is conventional and within the ordinary skill in such arts.

The phrase, “digital image file”, as used herein, refers to any digital image file, such as a digital still image or a digital video file.

A computer program product can include one or more storage media, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method(s) according various embodiment(s).

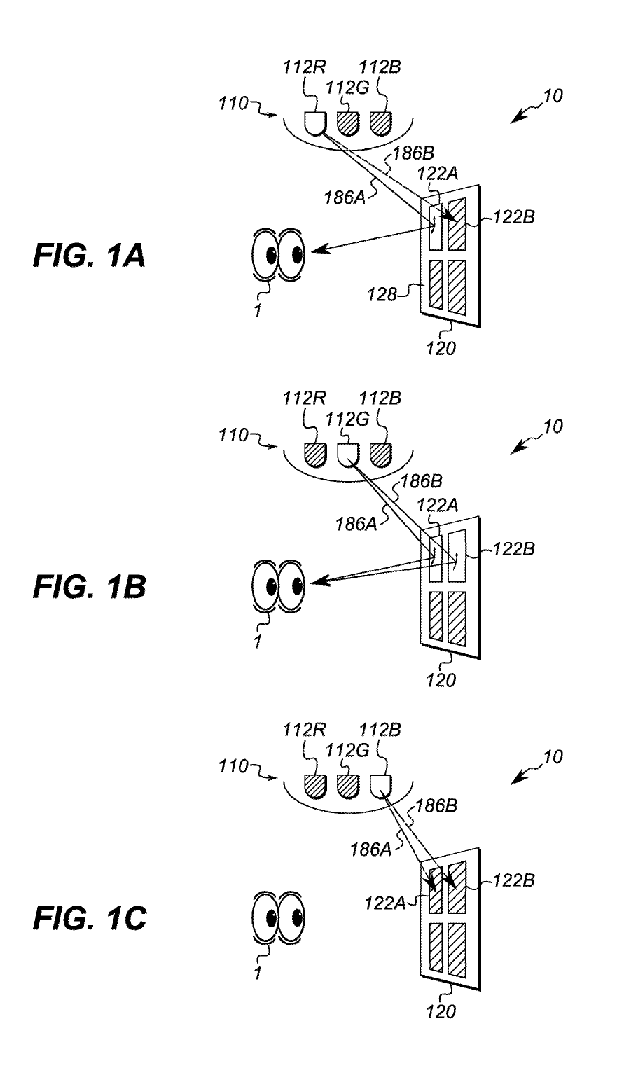

FIGS. 1A-1C show a color display system 10 at successive times. The color display system 10 displays a color image to viewer 1, where the color image has image data for a plurality of image color channels. The color display system 10 includes an illumination system 110 and a monochrome reflective display system 120.

The illumination system 110 includes a plurality of colored light sources 112R, 112G, 112B, each corresponding to an illumination color primary. For example, colored light source 112R can be a red light source, colored light source 112G can be a green light source, and colored light source 112B can be a blue light source. The colored light sources 112R, 112G, 112B can be LEDs, lamps, lasers, fluorescent tubes or other gas discharge lamps, or neon lamps or other glow-discharge lamps. In some embodiments, one or more of the colored light sources 112R, 112G, 112B can include a plurality of individual light-emitting elements (e.g., a plurality of individual LEDs, all having the same illumination color primary). In some embodiments, the colored light sources 112R, 112G, 112B can include respective color filters or neutral-density filters (the same or different) to adjust their color or light output. Light sources with hatching are used to denote light sources (e.g., colored light sources 112G, 112B in FIG. 1A) that are not providing light, and light sources without hatching are used to denote light sources (e.g., colored light sources 112R in FIG. 1A) that are providing light.

In some embodiments, one or more of the colored light sources in the illumination system 110 are white light sources or other neutrally-colored light sources at various luminance levels. The image color channels can include a neutral channel or a highlight channel. The image color channels can be intended to be mixed colorimetrically or not; for example, one of the image color channels can be used for strobes or other special effects. Any number of colored light sources can be used as long as there are at least two.

The monochrome reflective display system 120 includes a directly-viewable display surface 128 including an array of display pixels 122A, 122B. The display surface 128 can be flat or can be curved in one or more directions. The display surface 128 can position the display pixels 122A, 122B at one or more distance(s) from a selected aim viewer position. By “directly viewable” it is meant that viewer 1 views the display surface 128 without intervening focusing optics (other than human-worn corrective lenses, such as glasses to correct for nearsightedness or farsightedness). For example, light can travel directly from display surface 128 to the eye(s) of viewer 1 without intervening projection lenses. The directly-viewable display surface 128 can be separated from viewer 1 by magnification optics, filters, and corrective lenses for viewer 1. As used herein, the term “reflective” refers to a display or pixel designed to reflect incident illumination towards viewer 1. “Reflective” can also include transflective devices, which provide some reflection and some transmission.

Each display pixel 122A, 122B has a respective controllable reflectance. That is, each display pixel 122A, 122B on the display surface 128 can be controlled to reflect none, some, or all of the incident light towards viewer 1. In these figures, pixels with hatching are used to denote pixels (e.g., display pixel 122B in FIG. 1A) that are not reflecting light to viewer 1 and white (non-hatched) pixels are used to denote pixels (e.g., display pixel 122A in FIG. 1A) that are reflecting light to viewer 1. The reflection can be specular or diffuse. The reflectance of the display pixels 122A, 122B can be controlled in accordance with any type of display technology known in the art. In some embodiments, the display pixels 122A, 122B are controllable to provide a continuously variable level of reflectance. In some embodiments, the reflectance is controlled by controlling the reflectivity of the display pixels 122A, 122B. In other embodiments, the reflectance is controlled by controlling a reflectance direction. For example, the display pixels 122A, 122B can be micro-mirrors (e.g., as in Texas Instruments DLP display products), LCD elements and reflectors (e.g., as in commercially-available liquid-crystal displays), electrophoretic elements (e.g., as in EInk and Liquavista displays), differential refractors (e.g., as in Qualcomm mirasol displays), grating light valves (e.g., as described in commonly-assigned U.S. Pat. No. 6,243,194 to Brazas et al., entitled “Electro-mechanical grating device,” which is incorporated herein by reference), or other types of display elements that are adapted to selectively reflect light to viewer 1.

The display surface 128 is shown with a 2×2 array of display pixels 122A, 122B for illustration purposes. One skilled in the art will recognize that an actual display surface will generally have many thousands or even millions of display pixels. For example, a typical display surface 128 can have an 800×600 array of display pixels or a 1024×768 array of display pixels.

The term “monochrome” means that all display pixels 122A, 122B have the same color. That is, the monochrome reflective display system 120 itself does not include any elements designed to differentiate display pixels 122A, 122B into different display color channels. For example, individual red, green, and blue color filters are not associated with the display pixels 122A, 122B. In some embodiments, filters can be placed over display pixels 122A, 122B, but the same filter is placed over all pixels, or if different filters are used for different display pixels, those filters do not assign each display pixel to a specific display color channel. The use of the “monochrome” terminology relative to the monochrome reflective display system 120 should not be taken to imply that the color display system 10 can only produce neutrals or near-neutrals when lit by illumination system 110. Rather, differentiation between display color channels is provided by the illumination system 110, which successively provides light of different illumination color channels.

In the example shown in FIG. 1A, the colored light source 112R is activated and light rays 186A and 186B emitted by the colored light source 112R travel to display surface 128. The display pixels 122A and 122B are controlled to adjust the pattern of light that is reflected to viewer 1. Light ray 186A reflects off display pixel 122A diffusely, as indicated by the plurality of arrows leaving display pixel 122A. At least some of the reflected light reaches viewer 1, as indicated. Light ray 186B strikes display pixel 122B and is not reflected to viewer 1. Light ray 186B can be absorbed, reflected, diffracted, or otherwise deflected away from viewer 1, or a combination thereof.

In the example shown in FIG. 1B, light rays 186A and 186B emitted by the colored light source 112G travel to display surface 128. In this case, the display pixels 122A and 122B are controlled such that both light rays 186A and 186B are reflected to viewer 1. (Light ray 186A reflects off display pixel 122A and light ray 186B reflects off display pixel 122B.)

In the example shown in FIG. 1C, light rays 186A and 186B emitted by the colored light source 112B travel to display surface 128. In this case, the display pixels 122A and 122B are controlled such that neither of the light rays 186A and 186B are reflected to viewer 1. (Light ray 186A is absorbed or deflected by display pixel 122A and light ray 186B is absorbed or deflected by display pixel 122B.) Some stray light may still reach viewer 1 since optical systems generally cannot be constructed perfectly.

In this example, FIGS. 1A, 1B, and 1C represent successive states of operation of color display system 10. The illumination color primaries include red, green and blue primaries: colored light source 112R emits red light, colored light source 112G emits green light, and colored light source 112B emits blue light. If the states represented in FIGS. 1A-1C are presented rapidly in a repeating periodic pattern (e.g., at a frequency greater than 30 viewer 1 will perceive a color image. The time the color display system 10 spends in each state is referred to herein as the “slice time.” Higher slice frequencies (i.e., shorter slice times) provide reduced flicker. In this example, with high enough slice frequencies, display pixel 122A will appear yellow (since it reflects red and green light and absorbs blue light) and display pixel 122B will appear green (since it reflects only green light). The slice frequency is preferably no less than the frequency of image content to be displayed (e.g., 25 Hz, 30 Hz, 50 Hz or 60 Hz; interlaced or progressive) times the number of colored light sources. In this example, a 180 Hz slice rate can be used for a 60 Hz field rate and three colored light sources 112R, 112G, 112B.

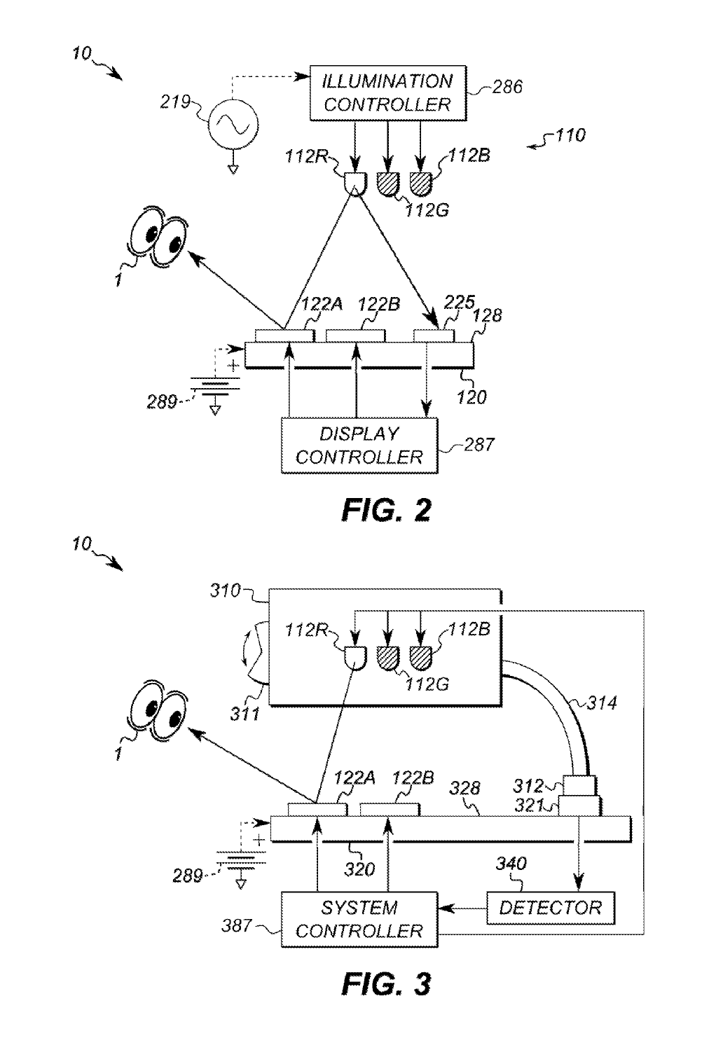

FIG. 2 shows details of the color display system 10 of FIGS. 1A-1C according to various embodiments. The colored light sources 112R, 112G, 112B, monochrome reflective display system 120, and display pixel 122A are as shown in FIGS. 1A-1C.

The illumination system 110 in FIG. 2 includes an illumination controller 286. The illumination controller 286 sequentially activates the colored light sources 112R, 112G, 112B according to a temporal sequence to provide illumination color channels corresponding to the plurality of image color channels. The illumination color channels can be the same as, a colorimetric match for, or different than the image color channels. For example, an input image in the well-known standard sRGB color space can be reproduced using a wide-gamut illumination system in which each illumination color primary has higher colorimetric purity than a corresponding one of the image color channels.

Moreover, each illumination color primary can correspond to exactly one image color channel, or one or more illumination color primaries can be used to provide a single image color channel. In various embodiments, only one illumination color channel is provided at a time, no matter how many (one or more) of the illumination color primaries is used to provide that illumination color channel. In various embodiments, at least one of the illumination color channels is provided using a mixture of light from two or more of the illumination color primaries, and those primaries are activated simultaneously or interleaved in a sequence at a higher frequency than the slice frequency, to provide the mixture of light. Continuing the example above, a wide-gamut illumination system 110 can provide sRGB illumination color channels by activating all three primaries at appropriate luminance levels during each slice. The red illumination color channel is provided by higher-luminance emission from red colored light source 112R and lower-luminance emission from green and blue colored light sources 112G, 112B. The green illumination color channel is provided by higher-luminance emission from green colored light source 112G and lower-luminance emission from red and blue colored light sources 112R, 112B. The blue illumination color channel is provided by higher-luminance emission from blue colored light source 112B and lower-luminance emission from red and green colored light sources 112R, 112G. The proportions of the colored light sources 112R, 112G, 112B used to provide a particular illumination color channel can be controlled to provide illumination having a specified chromaticity (e.g., the chromaticity of an sRGB primary). In various embodiments, the luminance levels for the individual colored light sources 112R, 112G, 112B can be controlled by adjusting the amplitude of the light output, or alternately by adjusting the pulse width for which the light sources are activated.

In some embodiments, at least two of the provided illumination color channels have substantially the same color (i.e., within Δu′ and Δv′<0.004) and have different luminances. For example, one illumination color channel can correspond to an illumination white point and can define L*=100. Another illumination color channel can supply additional illumination to provide for image highlights with L*=125. Both can have (a*, b*)≈(0, 0). In various embodiments, the second illumination color channel can be activated by itself, or can be activated in combination with the first illumination color channel to provide the higher illumination level.

In various embodiments, the temporal sequence is a periodic temporal sequence. That is, the slice time for each light source (e.g., colored light sources 112R, 112G, 112B) is constant or varies in a repeating pattern. In other embodiments, the temporal sequence is aperiodic or random. In various embodiments, different light sources are activated for different lengths of time. For example, blue is the lowest-luminance of the RGB primary set. The colored light source 112B producing the blue illumination color channel can be activated for a longer slice time than red colored light source 112R or green colored light source 112B to provide increased luminance of saturated blue colors. Slice frequencies can be any value, including >500 Hz or >1 kHz for very short, quickly-interleaved slices. The number of slices per illumination color channel in a temporal sequence can vary; different illumination color channels can be activated for the same or different numbers of slices before the pattern repeats.

In various embodiments, the color display system 10 includes a power supply 219 adapted to power the colored light sources 112B, 112G, 112R. Power supply 219 can include a connection to an electrical main (e.g., through a DC adapter). Power supply 289 is separate from the first power supply 219 and is adapted to power the display surface 128. In various embodiments, such as that in which power supply 219 is connected to an electrical main, power supply 289 includes a battery, supercapacitor, or other storage cell.

In an example, illumination system 110 is a room light system operated at a slice frequency fast enough that the viewer 1 does not perceive the separate slices (e.g., >60 Hz or >180 Hz). In an exemplary embodiment, the monochrome reflective display system 120 is a component of an electronic device (e.g., a portable electronic device such as a laptop computer, tablet computer, portable phone or media player, or other electronic device with a screen). When viewer 1 carries the monochrome reflective display system 120 into the room with the illumination system 110, the display surface 128 becomes a color display without requiring any intervention or conscious action by viewer 1. When viewer 1 removes monochrome reflective display system 120 from the room, the display surface 128 becomes a monochrome display, again automatically. This provides bright, high-saturation color displays in the room without requiring large batteries or reducing battery life to provide the light to the viewer 1. In various embodiments, color display system 10 can include a control permitting the user to enable or disable this automatic shift from monochrome to color.

In some embodiments, the monochrome reflective display system 120 includes a sensor 225 connected to display controller 287, which in turn controls the display pixels 122A, 122B. This is discussed further below.

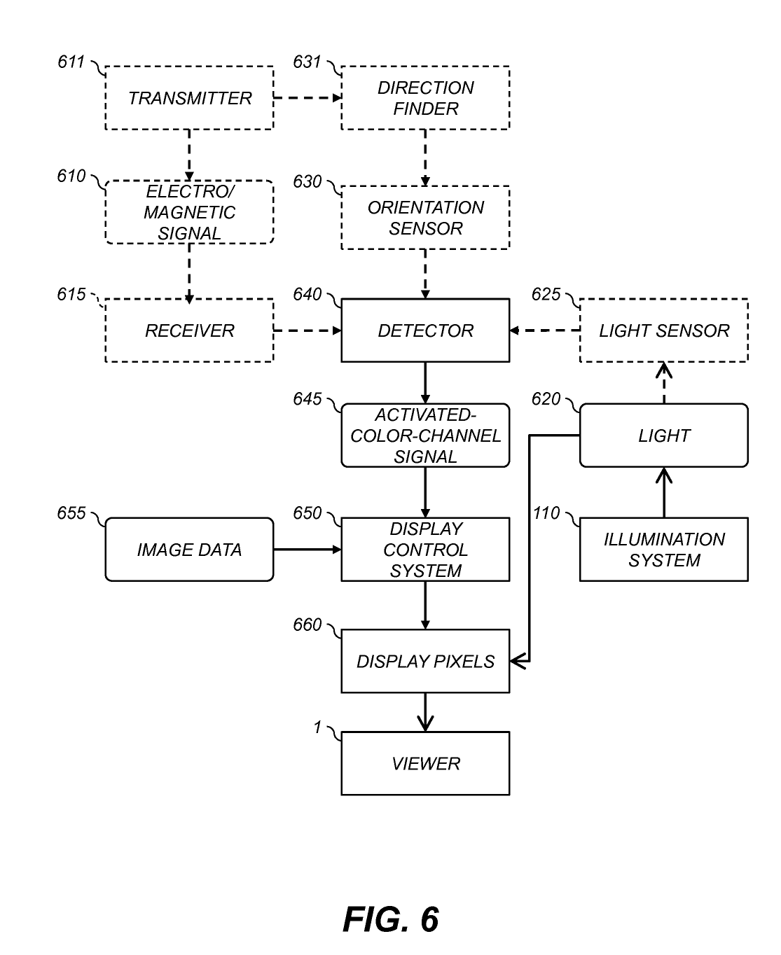

FIG. 6 shows a block diagram of display systems according to various embodiments. Detector 640 automatically detects an activated one of the illumination color channels being provided by illumination system 110 (FIG. 1) to display surface 128 (FIG. 1). If no illumination color channel is being provided by illumination system 110 to display surface 128, detector 640 also detects that fact. This can occur when illumination system 110 is turned off, is out of detection range of display surface 128, or is directed away from display surface 128. Detector 640 provides activated-color-channel signal 645 indicating whether illumination is being provided by the illumination system 110 and, if so, which illumination color channel is being provided.

Image data 655 for a color image having a plurality of image color channels are received from an external controller or storage device, or another image source, and provided to display control system 650. Display control system 650 also receives the activated-color-channel signal 645 from detector 640 and controls display pixels 660 in response to the activated-color-channel signal 645 and the image data 655. When the detector 640 detects the activated one of the illumination color channels, the display control system 650 controls reflectance of the display pixels 660 according to the image data 655 for the image color channel corresponding to the activated one of the illumination color channels specified by the activated-color-channel signal 645.

As the illumination system 110 activates different illumination color channels, the detector 640 provides updated activated-color-channel signals 645, and the display control system 650 updates the respective reflectances of the display pixels 660 according to the corresponding image color channel of the image data 655. In this situation, light 620 from illumination system 110 is selectively reflected from display pixels 660 to viewer 1 to show a color image (as indicated by the open-headed arrows).

When detector 640 detects that no illumination color channel is being provided to display surface 128 by illumination system 110 (or that the illumination level associated with the illumination color channel is too low), display control system 650 determines monochrome image data from image data 655 for one or more of the image color channels. Display control system 650 then controls the reflectances of display pixels 660 according to the determined monochrome image data. In this situation, ambient light in the viewing environment, or other light reaching display pixels 660, is selectively reflected from display pixels 660 to viewer 1 to show a monochrome image.

In this way, display control system 650 provides a color display when display surface 128 is illuminated by color-sequential light from illumination system 110. When display surface 128 is taken away from illumination system 110 or otherwise no longer illuminated thereby, the displayed image reverts to a monochrome image viewable under any condition of nonzero ambient illumination.

In various embodiments, the monochrome image data determined by display control system 650 corresponds to the image data for one of the image color channels. For example, the data for the green image color channel can be used, since that color channel's data most closely corresponds to luminance. Alternatively, if image data 655 has a luma image color channel and one or more chroma image color channels, the data for the luma image color channel can be used for the monochrome image data. In other embodiments, display control system 650 determines the monochrome image data by combining the image data 655 for a plurality of the image color channels. For example, if image data 655 has red, green, and blue image color channels, luma image data can be produced (e.g., Y=0.299R+0.587G+0.114B for ITU-R Rec. BT.601 video) and used as the monochrome image data.

In various embodiments, the color image is a stereoscopic anaglyph image that is used to encode a left-eye image and a right-eye image. Stereoscopic anaglyph images are well-known in the art. In a stereoscopic anaglyph image, one or more of the image color channels (e.g., the red color channel) is used for the left-eye image, and another one or more of the image color channels (e.g., the green and blue color channels) are used for the right-eye image. Under light from illumination system 110, the image is a 3-D anaglyph image which can be viewed by the viewer 1 using anaglyph glasses (e.g., glasses having two differently-colored filters over the viewer's eyes). Outside that light, the image is displayed as a standard 2-D image. In various embodiments, the image data for either the left-eye image or the right-eye image is used to form the monochrome image data.

Detector 640 can operate in various ways. In some embodiments, detector 640 includes light sensor 625. Light sensor 625 senses light 620 from illumination system 110 to detect the activated one of the illumination color channels. The light sensor 625 can include one or more light sensing elements such as CCD or CMOS sensors, CdS cells, photodiodes or phototransistors, or other types of photosensitive elements. In some embodiments, the light sensor 625 correspond to sensor 225 (FIG. 2) and display control system 650 corresponds to display controller 287 (FIG. 2).

In various embodiments, detector 640 detects each illumination color channel individually. The light sensor 625 can be an RGB sensor that includes a plurality of light sensing elements, each having a spectral sensitivity corresponding to one of the illumination color channels. For example, a red-sensitive light sensing element can be provided to sense a red illumination color channel, a green-sensitive light sensing element can be provided to sense a green illumination color channel, and a blue-sensitive light sensing element can be provided to sense a blue illumination color channel. The relative amplitudes of the signals from the light sensing elements can be used to determine which of the illumination color channels is activated. For example, if the signal from the red-sensitive light sensing element exceeds the signal from the green- and blue-sensitive light sensing elements, it can be inferred that the red illumination color channel is currently activated. In some embodiments, the relative amplitudes of the signals from the light sensing elements can be used to estimate the chromaticity of the incident illumination. The detector 640 can then determine which illumination color channel most closely matches the incoming light colorimetrically. If the incoming light has luminance below a selected threshold (e.g., 1 nit) or does not match the chromaticity of any of the illumination color channel within a selected threshold (e.g., Δu′>T_{C} or Δv′>T_{C}, where T_{C} is a chromaticity difference threshold), the detector 640 determines that no illumination color channel is being provided.

In other embodiments, one or more, but fewer than all, of the illumination color channels are detected individually. For example, the green illumination color channel can be detected using a sensor with a V(λ) or similar response. In embodiments in which the sequence of color slices is known (e.g., always red, green, blue for equal amounts of time), the cadence of the green illumination channel contains enough information to determine when the red and blue illumination color channels are active (e.g., using a phase-locked loop (PLL) that locks onto the green signal).

In other embodiments, the detector 640 includes a receiver 615 adapted to receive an electrical, magnetic, or electromagnetic signal (denoted as electro/magnetic signal 610) transmitted by a transmitter 611 that is associated with the illumination system 110. The transmitter 611 can be part of illumination system 110 or separate therefrom. The electro/magnetic signal 610 provides an indication of the activated one of the illumination color channels. Detector 640 provides activated-color-channel signal 645 responsive to the received electro/magnetic signal 610. In various embodiments, the transmitter 611 provides an electromagnetic strobe pulse per frame/field, or per slice. Detector 640 provides the information from electro/magnetic signal 610 as activated-color-channel signal 645, or locks on to electro/magnetic signal 610 with a PLL and time-divides to produce activated-color-channel signal 645.

In some embodiments using receiver 615, detector 640 also includes orientation sensor 630 adapted to detect an orientation of display surface 128 (or the monochrome reflective display system 120 of which the display surface 128 is part). For example, the orientation sensor 630 can include a gyroscope, MEMS accelerometer, or radio direction finder. Detector 640 provides the activated-color-channel using the received signal and the detected orientation. Therefore, activated-color-channel signal 645 indicates that no illumination color channel is being provided by illumination system 110 to display surface 128 if display surface 128 is oriented away from illumination system 110. This permits fallback to monochrome display if the display is turned away from the light source, which can be useful in various applications, such as those in which the color display is required to be high brightness. In other applications, diffuse or indirect light from illumination system 110 is sufficient to trigger color display, so the threshold at which detector 640 considers display surface 128 to be oriented away from illumination system 110 can be selected appropriately.

In an example, orientation sensor 630 includes direction finder 631. Direction finder 631 detects the orientation of display surface 128 with respect to transmitter 611 of electro/magnetic signal 610. Direction finder 631 can include an automatic direction-finder (ADF) receiver such as those used in aircraft, or an array of antennas with various orientations.

In various embodiments, the detector 640 includes a combination of light sensors 625, receivers 615, or orientation sensors 630.

FIG. 3 shows color display system 10 according to various embodiments. Colored light sources 112R, 112G, 112B, viewer 1, and display pixels 122A, 122B are as shown in FIG. 1. In these embodiments, illumination system 310 is removably attachable to monochrome reflective display system 320 that includes a directly-viewable display surface 328. Specifically, illumination system 310 includes connector 312 and monochrome reflective display system 320 includes connector 321. Connectors 312 and 321 mate to connect the two systems.

In various embodiments, monochrome reflective display system 320 further includes power supply 289 (e.g., a battery) for powering both the illumination system 310 and the monochrome reflective display system 320. Power is provided through connectors 312, 321. In some embodiments, a viewer interface 311 (e.g., a power switch) can be provided as part of the illumination system 310 to enable the user to turn power to the illumination system 310 on or off. This enables the color display system 10 to be used in a lower-power monochrome display mode even when the illumination system 310 is connected to the monochrome reflective display system 320.

In the embodiment shown, illumination system 310 is mounted using mounting bracket 314, which enables changing the orientation of colored light sources 112R, 112G, 112B in the illumination system 310 with respect to monochrome reflective display system 320. Mounting bracket 314 can be fixed, or can be a flexible arm to permit the angle of incident light to be adjusted. Other types of mounts can also be used to mount the illumination system 310, including mounts in which light is directed from illumination system 310 through a plastic or other substantially-transparent light guide down the face of display surface 328. Specifically, in various embodiments, illumination system 330 includes connector 312 for selectively connecting to monochrome reflective display system 320 and mounting bracket 314 for mechanically connecting connector 312 to the colored light sources 112R, 112G, 112B in the illumination system 310.

In various embodiments, the color display system shown in FIG. 3 includes illumination system 310, as discussed above. Monochrome reflective display system 320 is removably connectable to illumination system 310, and includes directly-viewable display surface 328, as discussed above. Detector 340 automatically detects whether or not illumination system 310 is connected to monochrome reflective display system 320, for example by detecting the voltage of a conductor passed through connectors 312, 321, pulled up in monochrome reflective display system 320, and strapped low in illumination system 310. Detector 340 provides a corresponding connection signal.

System controller 387 controls display pixels 122A, 122B and illumination system 310 in response to the connection signal provided by the detector 340. When detector 340 detects that illumination system 310 is connected to the monochrome reflective display system 320 and is powered (i.e., not disabled by the viewer interface 311), system controller 387 activates colored light sources 112R, 112G, 112B according to a temporal sequence, as discussed above. This sequentially provides a plurality of illumination color channels corresponding to the image color channels. System controller 387 then controls the respective reflectances of the display pixels 122A, 122B in synchronization with the illumination color channels, doing so according to the image data for the image color channel corresponding to each successively activated one of the illumination color channels.

When detector 340 detects that illumination system 310 is not connected to the monochrome reflective display system 320, system controller 387 determines monochrome image data from the image data for one or more of the image color channels, as described above. System controller 387 then controls the reflectance (i.e., the respective reflectances) of display pixels 122A, 122B according to the monochrome image data. This configuration provides a full-color display mode when a suitable full-color slice-sequential illumination system 310 is connected, and provides a lower-power monochrome display mode when the illumination system 310 is disconnected.

In various embodiments, detector 340 can be used together with light sensor 625 (FIG. 6) or orientation sensor 630 (FIG. 6). Specifically, detector 340 can further automatically detect an activated one of the illumination color channels being provided by illumination system 310 to display surface 328, or that no illumination color channel is being provided by illumination system 310 to display surface 328, and providing an activated-color-channel signal, as discussed above with respect to FIG. 6. Therefore, if system controller 387 has activated an illumination color channel but the lights are facing away from the display surface 328, the activated-color-channel signal 645 (FIG. 6) will indicate this condition. System controller 387 receives the activated-color-channel signal 645 and controls the reflectance of the display pixels according to the image data for the image color channel corresponding to the activated one of the illumination color channels in response to detector 340 detecting the activated illumination color channel. System controller 387 controls the reflectance of display pixels 122A, 122B according to the monochrome image data in response to detector 340 detecting that no illumination color channel is being provided to the display surface 328 by illumination system 310.

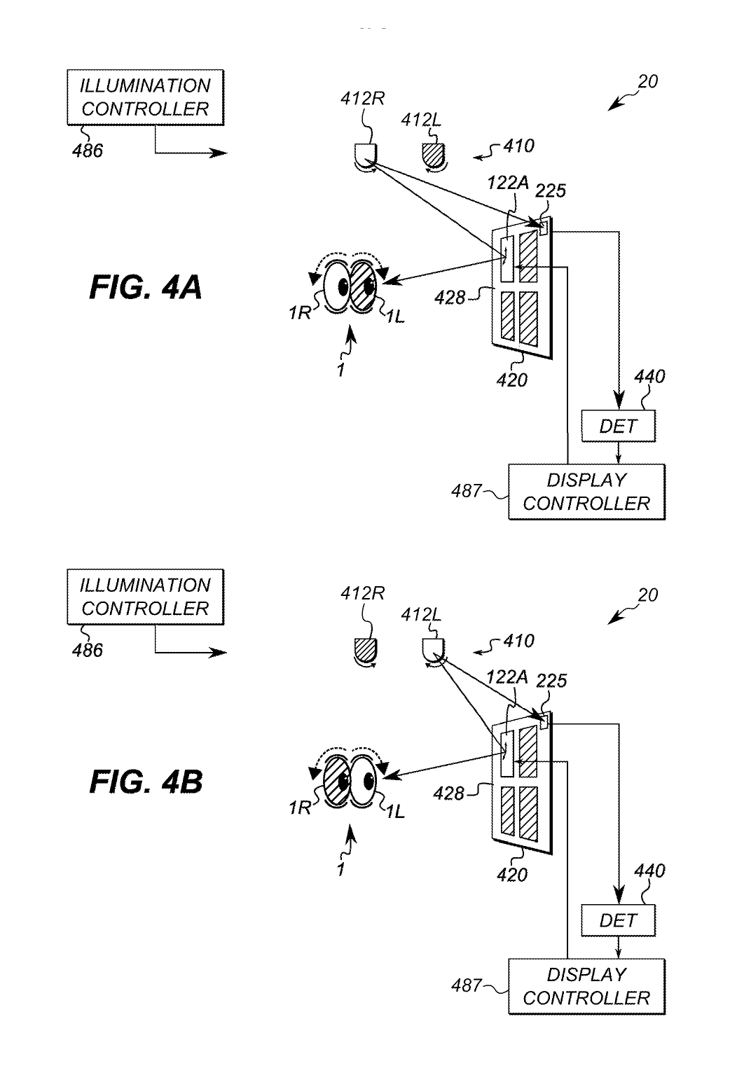

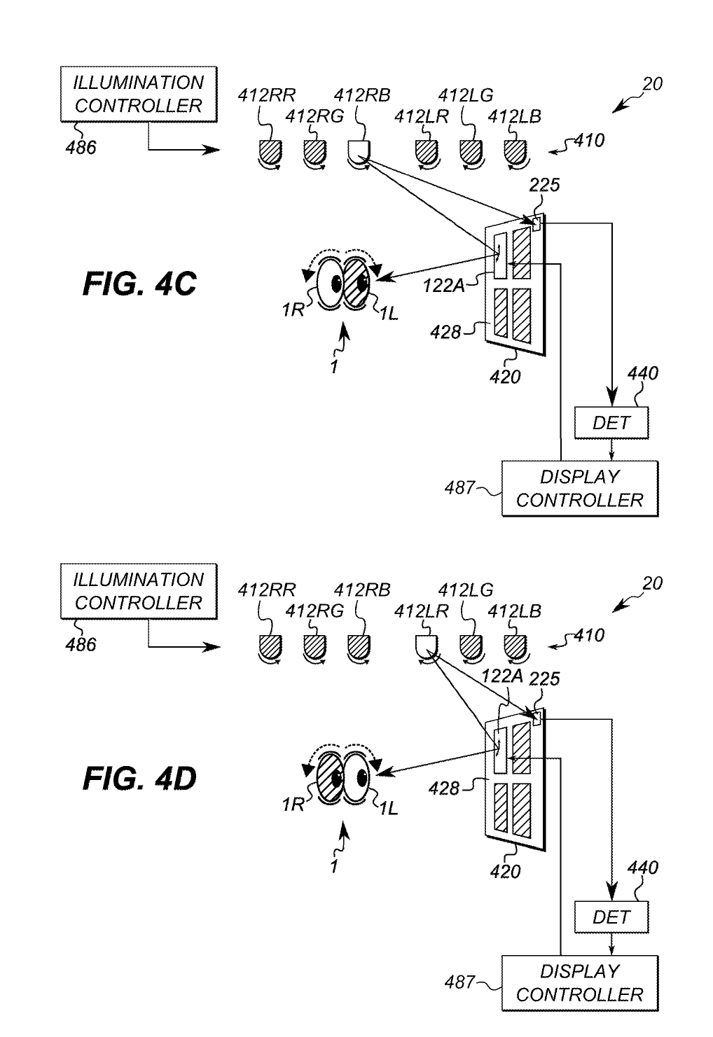

FIGS. 4A-4D show stereoscopic display systems 20 according to various embodiments. These stereoscopic display systems 20 display a stereoscopic image having image data for a left-eye image channel and a right-eye image channel. Viewer 1 has left eye 1L and right eye 1R. The stereoscopic display system 20 includes illumination system 410 and monochrome reflective display system 420.

FIGS. 4A-4B show an embodiment of stereoscopic display system 20 that includes an illumination system 410 having a left-eye light sources 412L providing light having a first optical property and a right-eye light source 412R providing light having a second optical property different from the first optical property. The two optical properties are represented graphically in FIGS. 4A-4B as circular arcs pointing counter-clockwise for the first optical property or clockwise for the second optical property.

In some embodiments, the first optical property is a first polarization state and the second optical property is a second polarization state. For example, the two optical properties can be opposite handednesses of circular polarization, or one can be 0° linear polarization and the other 90° linear polarization. In such embodiments, the viewer 1 is provided with viewing glasses (not shown) having polarization filters for the two eyes corresponding to the two polarization states so that each eye sees light from only the corresponding polarization state.

In other embodiments, the first optical property is a first-eye color and the second optical property is a second-eye color. In such embodiments, the viewer 1 is provided with viewing glasses (not shown) having colored filters for the two eyes corresponding to the first-eye and second-eye colors so that each eye sees light from only the color state.

In other embodiments, the first optical property is a first direction of incidence and the second optical property is a second direction of incidence. The different angles of incidence for the light provided by the left-eye light sources 412L and the right-eye light source 412R can be used to differentially direct the light reflected from the display pixels 122A toward the eyes of the viewer 1.

Illumination controller 486 sequentially activates left-eye light source 412L and right-eye light source 412R according to a temporal sequence. This is as discussed above with respect to illumination controller 286 (FIG. 2), but the controller activates light sources for two eyes instead of for two color channels.

Monochrome reflective display system 420 includes directly-viewable display surface 428 including an array of display pixels (e.g., display pixel 122A), each having a respective controllable reflectance. This is as discussed above with respect to display surface 128 (FIGS. 1A-1C).

Detector 440 automatically detects that light from left-eye light source 412L is being provided to display surface 428 by illumination system 410, that light from right-eye light source 412R is being provided to the display surface 428 by the illumination system 410, or that neither light from left-eye light source 412L nor light from right-eye light source 412R is being provided to display surface 428 by illumination system 410. Detector 440 provides a corresponding activated-eye signal to display controller 487. The detector 440 corresponds to detector 640 described above with respect to FIG. 6, but detecting a stereo channel instead of a color channel. For example, detector 440 can include one or two light sensors 225 with polarized filters to detect light of one or more particular polarizations. The detector 440 can also include an area photo-sensor capped with a lens to permit determining the direction from which incident light originates. PLLs and other techniques described with respect to detector 640 can also be used with detector 440.

Display controller 487 controls display pixels (e.g., display pixel 122A) in response to the activated-eye signal from detector 440. When the left eye is active (i.e., when the activated-eye signal indicates that light from left-eye light source 412L is being provided to display surface 428), display controller 487 controls the reflectance of the display pixels (e.g., display pixel 122A) according to the image data for the left-eye image channel. Likewise, when the right-eye light source 412R is activated, display controller 487 controls the reflectance of the display pixels (e.g., display pixel 122A) according to the image data for the right-eye image channel. When the detector 440 detects that neither light from left-eye light source 412L nor light from right-eye light source 412R is being provided to the display surface 428, display controller 487 determines monoscopic image data from either the image data for the left-eye image channel or the image data for the right-eye image channel, or a combination thereof. Display controller 487 then controls the reflectance of the display pixels (e.g., display pixel 122A) according to the determined monoscopic image data.

In various embodiments in which the optical property is angle of incidence, the display pixels (e.g., display pixel 122A) have a reflection characteristic that is at least in part specular. Display controller 287 controls a reflectance direction of the display pixels so that light from left-eye light source 412L is specularly reflected to a selected left-eye position of left eye 1L, and light from right-eye light source 412R is specularly reflected to a selected right-eye position of right eye 1R. The selected positions can be selected based on a fixed position of viewer 1. This can be useful, for example, in applications on handheld displays such as the NINTENDO 3DS. Alternatively, the position of the eyes or pupils of viewer 1 can be tracked, and the selected positions updated over time with the results of the tracking. The positions of the light sources (e.g., left-eye light source 412L and right-eye light source 412R) can also be tracked to determine the appropriate angle to specularly reflect light from a selected light source into the selected eye of viewer 1.

In some of these embodiments, a control (not shown) is provided that permits viewer 1 to provide input to display controller 287. The control receives an indication of the spacing between the eyes of viewer 1. Display controller 287 selects the left-eye position and the right-eye position according to the received indication. This adjustment is similar to that provided by the 3D depth slider in the NINTENDO 3DS.

FIG. 4A shows light from right-eye light source 412R reflecting off display pixel 122A and reaching right eye 1R. The light does not reach left eye 1L (as represented graphically by the hatching over left eye 1L). The light does reach sensor 225, described above which senses that the right-eye light source 412R is active. FIG. 4B shows light from left-eye light source 412L reaching left eye 1L and sensor 225, but not right eye 1R.

Referring to FIGS. 4C-4D, some embodiments of the stereoscopic display system 20 are stereoscopic color display systems. These display a stereoscopic color image having image data for a plurality of left-eye image color channels and a plurality of right-eye image color channels. Illumination system 410 includes a plurality of left-eye colored light sources 412LR, 412LG, 412LB, each of which provides light corresponding to an illumination color primary (as described above with reference to FIGS. 1A-1C) and having a first optical property (as described above with reference to FIGS. 4A-4B). Illumination system 410 also includes a plurality of right-eye colored light sources 412RR, 412RG, 412RB, each of which provides light corresponding to an illumination color primary (as described above with reference to FIGS. 1A-1C) and having a second optical property different from the first optical property (as described above with reference to FIGS. 4A-4B). In various embodiments, each left-eye colored light source 412LR, 412LG, 412LB provides light having a first polarization state and each right-eye colored light source 412RR, 412RG, 412RB provides light having a second polarization state different from the first polarization state. As described above with respect to FIGS. 1A-1C, the left-eye colored light sources 412LR, 412LG, 412LB can be activated one at a time, or can be combined to provide left-eye illumination color channels. Likewise, the right-eye colored light sources 412RR, 412RG, 412RB can be activated one at a time, or can be combined to provide right-eye illumination color channels.

In these embodiments, illumination controller 486 sequentially activates the left-eye colored light sources 412LR, 412LG, 412LB and the right-eye colored light sources 412RR, 412RG, 412RB according to a temporal sequence to provide the left-eye and right-eye illumination color channels. This corresponds to the sequences described above with reference to FIGS. 1A-1C, except that left-eye and right-eye light sources are activated. The left-eye and right-eye sources can be activated in various sequences. For example, they can be activated in groups (e.g., all the left-eye colors, then all the right-eye colors) or interleaved (e.g., left red, right red, left green, right green, left blue, right blue). All the options described herein for temporal sequences can be used for color stereoscopic sequences.

Detector 440 associated with monochrome reflective display system 420 automatically detects an active one of the left eye or the right eye illumination color channels for which light is being provided by the illumination system 410 to display surface 428, or that no light appropriate for either eye is being provided to display surface 428 by the illumination system 410. Detector 440 provides an activated-eye-and-color signal providing this information to display controller 487.

Display controller 487 then controls the display pixels (e.g., display pixel 122A) in response to the activated-eye-and-color signal. When detector 440 detects (by any way discussed above, e.g., as in FIG. 6) the active eye and active illumination color channel, display controller 487 controls the reflectance of the display pixels (e.g., display pixel 122A) according to the image data for the active eye and the image color channel corresponding to the active illumination color channel. When detector 440 detects that no light (or insufficient light) appropriate for either eye is being provided by illumination system 410 to display surface 428, a monoscopic display is provided. This can occur, for example, when the display surface 428 is not illuminated, or when the display surface 428 is illuminated by conventional fluorescent or incandescent lights that do not provide light of different optical properties for the left eye and the right eye. In these situations, display controller 487 determines monoscopic, monochrome image data from the image data for one or more of the left-eye or right-eye (or both) image color channels. Display controller 487 then controls the reflectance of the display pixels (e.g., display pixel 122A) according to the determined monoscopic, monochrome image data, so that the stereoscopic color display system functions as a monoscopic monochrome display system. The monochrome monoscopic image data can be determined by combining any of the ways described herein of producing monochrome image data and any of the ways described herein of producing monoscopic image data. For example, luma data can be generated from the color image data for the right-eye image, and that luma data can be used as the monochrome, monoscopic image data.

In various embodiments, detector 440 detects the color and the stereoscopic eye independently. If multiple colors of illumination are being provided, but for only one eye, display controller 487 produces color monoscopic image data and causes it to be displayed. If left-eye and right-eye monochrome illumination is being provided, display controller 487 produces monochrome stereoscopic image data and causes it to be displayed.

FIG. 4C shows a time slice where the illumination system 410 is providing the blue color channel to the right eye 1R of the viewer 1, using right-eye colored light source 412RB. Similarly, FIG. 4D shows another time slice where the illumination system 410 is providing the red color channel to the left eye 1L of the viewer 1, using left-eye colored light source 412LR.

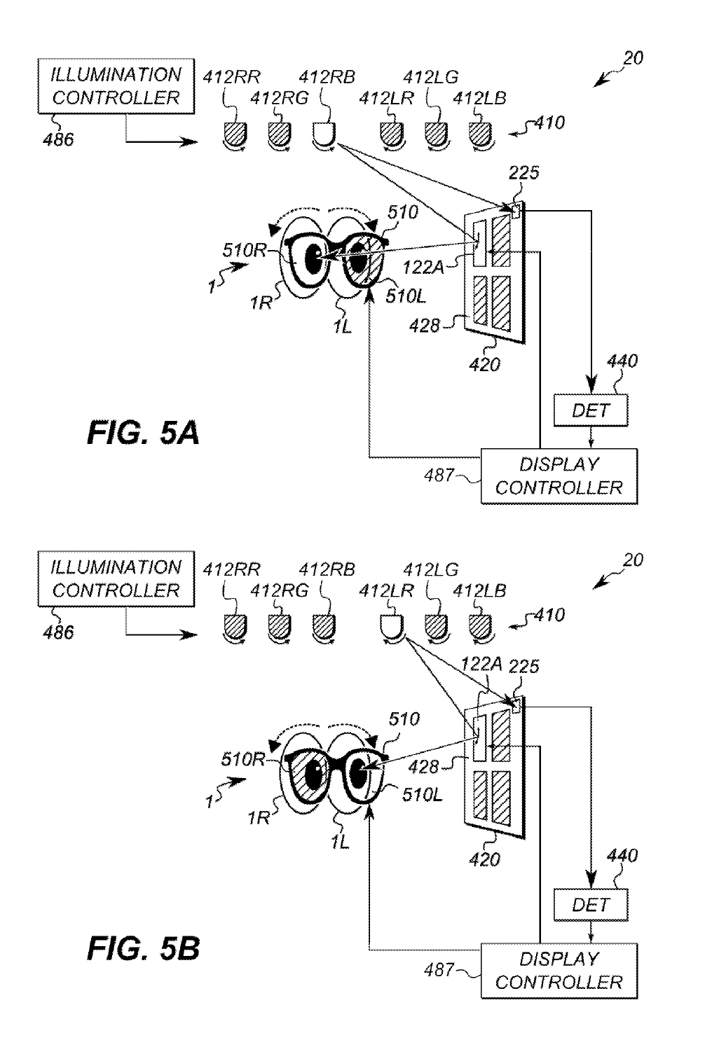

FIGS. 5A-5B show an embodiment of a color stereoscopic display system 20, which includes an illumination system 410 (with left-eye colored light sources 412LR, 412LG, 412LB and right-eye colored light sources 412RR, 412RG, 412RB) and a monochrome reflective display system 420, viewed by viewer 1, having a left eye 1L and a right eye 1R. The monochrome reflective display system 420 includes display controller 487, display surface 428 having display pixels 122A and sensor 225.

Viewer 1 is wearing glasses 510 with element 510L (over left eye 1L) and element 510R (over right eye 1R). In some embodiments, elements 510L and 510R are polarizing filters with different polarizations. In this case, the left-eye element 510L transmits light having a polarization state associated with the left-eye colored light sources 412LR, 412LG, 412LB and absorbs light having a polarization state associated with the right-eye colored light sources 412RR, 412RG, 412RB. Similarly, the right-eye element 510R transmits light having a polarization state associated with the right-eye colored light sources 412RR, 412RG, 412RB and absorbs light having a polarization state associated with the left-eye colored light sources 412LR, 412LG, 412LB.

In other embodiments, glasses 510 are a pair of shutter glasses, where elements 510L and 510R are a left-eye shutter and a right-eye shutter, respectively. In this case, the display controller 487 controls glasses 510 to open the left-eye shutter (element 510L) and close the right-eye shutter (element 510R) while the left eye is the active eye, and controls the glasses 510 to open the right-eye shutter (element 510R) and close the left-eye shutter (element 510L) while the right eye is the active eye.

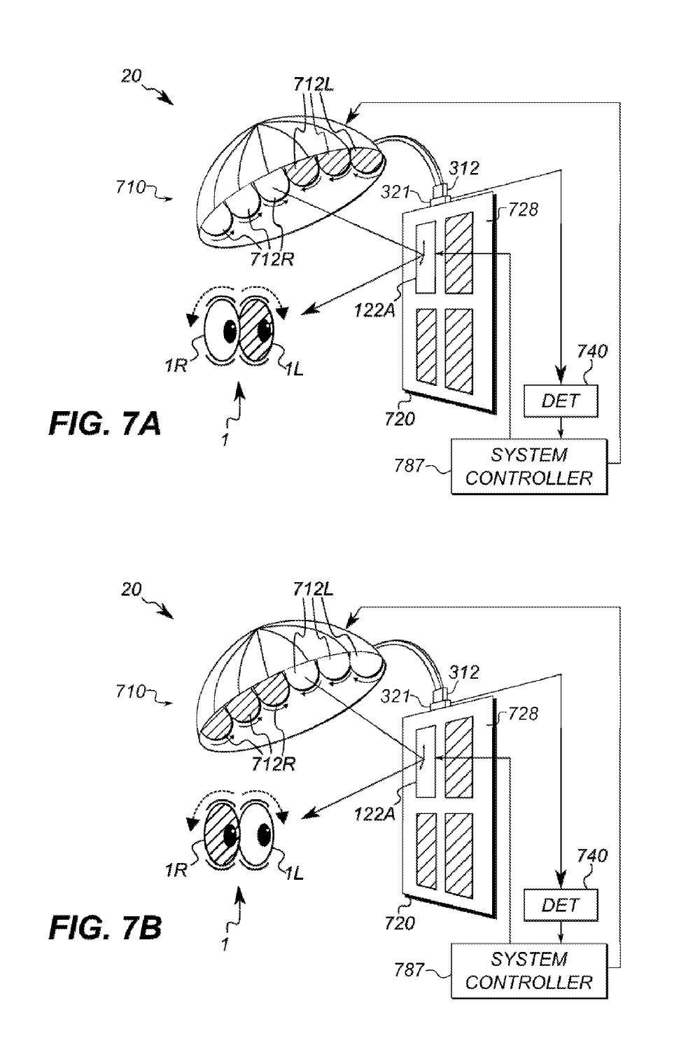

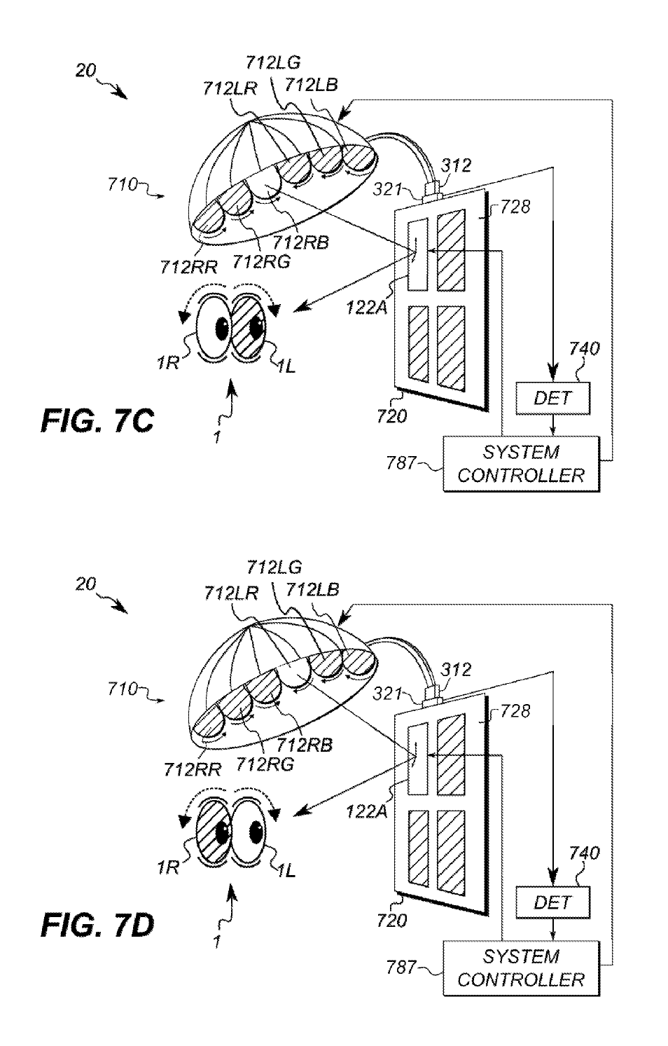

FIGS. 7A-7B show another exemplary embodiment of a stereoscopic display system 20. Components are not shown to scale. In the example shown, illumination system 710 includes left-eye light sources 712L and right-eye light sources 712R (e.g., LED light sources). In this example, three individual light sources are shown of each type, although it will be recognized that various embodiments can use different numbers of individual light sources. The significance of the hatching and the arrows is as shown in the illumination system 410 of FIGS. 4A-4B. Illumination system 710 includes connector 312 that connects to connector 321 on monochrome reflective display system 720, as shown in FIG. 3.

Specifically, a stereoscopic display system for displaying a stereoscopic image having image data for a left-eye image channel and a right-eye image channel includes illumination system 710. Left-eye light source 712L provides light having a first optical property, and right-eye light source 712R provides light having a second optical property different from the first optical property, as discussed above with respect to FIGS. 4A-4B.

Monochrome reflective display system 720 is removably connectable to the illumination system 710 through connectors 312, 321. Monochrome reflective display system 720 includes a directly-viewable display surface 728 including an array of display pixels (e.g., display pixel 122A), each display pixel having a respective controllable reflectance. The display pixels (e.g., display pixel 122A) preserve or selectively transform the optical properties of the light provided by the light sources in the illumination system 710, as is discussed below. Detector 740 automatically detects whether or not illumination system 710 is connected to monochrome reflective display system 720 and provides a corresponding connection signal. System controller 787 controls the display pixels (e.g., display pixel 122A) and illumination system 710 in response to the connection signal. When the detector 740 detects that illumination system 710 is connected to monochrome reflective display system 720, system controller 787 sequentially activates the light sources in the illumination system 710 according to a temporal sequence, and controls the reflectance of the display pixels (e.g., display pixel 122A) in synchronization with the activation of the light sources according to the image data for the left-eye image channel when the left-eye light source 712L is activated (as in FIG. 7B) and according to the image data for the right-eye image channel when the right-eye light source 712R is activated (as in FIG. 7A). When the detector detects that illumination system 710 is not connected to monochrome reflective display system 720, system controller 787 determines monoscopic image data from the image data for the left-eye image channel or the image data for the right-eye image channel, or a combination thereof, and controls the reflectance of the display pixels (e.g., display pixel 122A) according to the monoscopic image data. As discussed above, other sensors (e.g., light sensor 625 in FIG. 6) can also be used by system controller 787 along with detector 740.

As discussed above, the first optical property can be a first polarization state and the second optical property a second polarization state. The first optical property can alternatively be a first direction of incidence and the second optical property a second direction of incidence. In some of the latter embodiments, the display pixels (e.g., display pixel 122A) have a reflection characteristic that is at least in part specular. System controller 787 controls the display pixels so that light from left-eye light source 712L is specularly reflected to a selected left-eye position of left eye 1L, and light from right-eye light source 712R is specularly reflected to a selected right-eye position of right eye 1R. As discussed above, eye tracking or gaze tracking can be used to determine the positions, or an assumption can be made that viewer 1 is at a fixed location. A control can be provided (e.g., to viewer 1) for receiving an indication of the spacing between the left eye 1L and right eye 1R of viewer 1, and system controller 787 can select the left-eye position and the right-eye position according to the received indication.

As mentioned above, the display pixels (e.g., display pixel 122A) preserve or selectively transform the optical properties of the light received from the illumination system 710. For example, if the optical properties are respective, different handednesses of circular polarization, the pixels either preserve that handedness or change it to the opposite handedness. For example, it is known that circularly-polarized light changes handedness when it reflects specularly off an aluminum reflector. In embodiments in which the display pixels similarly change handedness, viewer 1 can wear polarized glasses 510 (FIG. 5). The left eye of the glasses can transmit the same handedness of polarization as the reflected light from the left-eye light source 712L, and the right eye of the glasses can transmit the same handedness of polarization as the reflected light from the right-eye light source 712R, where the polarization state of the light from each light source is reversed in handedness when reflecting off a display pixel.

FIG. 7A shows light from right-eye light source 712R reaching right eye 1R. FIG. 7B shows light from left-eye light source 712L reaching left eye 1L. In this embodiment, the right-eye light sources 712R and the left-eye light sources 712L can be neutral (e.g., white) light sources having different optical properties, or can have other specified spectral characteristics.

FIGS. 7C-7D show an exemplary embodiment of a color stereoscopic display system 20 for displaying a stereoscopic color image having image data for a plurality of left-eye image color channels and a plurality of right-eye image color channels. The color stereoscopic display system 20 includes illumination system 710 and monochrome reflective display system 720. Illumination system 710 includes a plurality of left-eye colored light sources (e.g., red left-eye colored light source 712LR, green left-eye colored light source 712LG and blue left-eye colored light source 712LB). Each left-eye colored light sources provides light corresponding to an illumination color primary having a first optical property. Each of a plurality of right-eye light sources (e.g., red right-eye colored light source 712RR, green right-eye colored light source 712RG and blue right-eye colored light source 712RB) provides light corresponding to an illumination color primary having a second optical property.

Monochrome reflective display system 720 is removably connectable to illumination system 710 and includes directly-viewable display surface 728 including an array of display pixels (e.g., display pixel 122A), each having a respective controllable reflectance. This is as described above. Detector 740 automatically detects whether or not illumination system 710 is connected to monochrome reflective display system 720 and provides a corresponding connection signal.

System controller 787 controls the display pixels (e.g., display pixel 122A) and illumination system 710 in response to the connection signal from detector 740. When detector 740 detects that illumination system 710 is connected to monochrome reflective display system 720 and powered, system controller 787 activates the left-eye and right-eye colored light sources to sequentially provide a plurality of illumination color channels corresponding to the left-eye and right-eye image color channels. Each active (i.e., emitting light) illumination color channel is directed to a respective active eye (e.g., right) and a respective active image color channel (e.g., blue). System controller 787 controls the reflectance of the display pixels (e.g., display pixel 122A) according to the image data for each successive active eye and active one of the illumination color channels while the illumination channels are sequentially provided, and in synchronization therewith. The reflectance of the display pixels (e.g., display pixel 122A) and the active illumination color channel can be changed at the same time, or within a certain time of each other. For example, the image data can be stable before or after the illumination is provided.

When detector 740 detects that illumination system 710 is not connected to monochrome reflective display system 720 or is not powered (e.g., is disabled by viewer interface 311 shown in FIG. 3), system controller 787 determines monoscopic, monochrome image data from the image data for one or more of the left-eye or right-eye (or both) image color channels. System controller 787 then controls the reflectance of the display pixels (e.g., display pixel 122A) according to the monoscopic, monochrome image data so that the color stereoscopic display system 20 functions as a monoscopic, monochrome display system.

As discussed above, in various embodiments, each left-eye colored light source 712LR, 712LG, 712LB provides light having a first polarization state. Each right-eye colored light source 712RR, 712RG, 712RB provides light having a second polarization state different from the first polarization state.

As discussed above, in other embodiments, a pair of shutter glasses includes a left-eye shutter and a right-eye shutter. System controller 787 controls the glasses to open the left-eye shutter and close the right-eye shutter while the left eye is the active eye and controls the glasses to open the right-eye shutter and close the left-eye shutter while the right eye is the active eye. In embodiments where shutter glasses are used to control which eye receives the light provided by the illumination system 710, it is not necessary to have two complete sets of light sources (i.e., a set of left-eye light sources and a second set of right-eye light sources). Rather a single set of colored light sources having different color primaries can be used to provide the light for the left eye image and the right eye image, and the shutter glasses can be controlled in synchronization with the display pixels (e.g., display pixel 122A) in order to provide the left-eye image to the left-eye 1L and the right-eye image to the right-eye 1R. In this way, embodiments such as that shown in FIG. 3 can be used to provide a color stereoscopic image.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. The word “or” is used in this disclosure in a non-exclusive sense, unless otherwise explicitly noted.

The invention has been described in detail with particular reference to certain preferred embodiments thereof, but it will be understood that variations, combinations, and modifications can be effected by a person of ordinary skill in the art within the spirit and scope of the invention.

### PARTS LIST

1 viewer
1L left eye
1R right eye
10 color display system
20 stereoscopic display system
110 illumination system
112B colored light source
112G colored light source
112R colored light source
120 monochrome reflective display system
122A display pixel
122B display pixel
128 display surface
186A light ray
186B light ray
219 power supply
225 sensor
286 illumination controller
287 display controller
289 power supply
310 illumination system
311 viewer interface
312 connector
314 mounting bracket
320 monochrome reflective display system
321 connector
328 display surface
340 detector
387 system controller
410 illumination system
412L left-eye light source
412LB left-eye colored light source
412LG left-eye colored light source
412LR left-eye colored light source
412R right-eye light source
412RB right-eye colored light source
412RG right-eye colored light source
412RR right-eye colored light source
420 monochrome reflective display system
428 display surface
440 detector
486 illumination controller
487 display controller
510 glasses
510L element
510R element
610 electro/magnetic signal
611 transmitter
615 receiver
620 light
625 light sensor(s)
630 orientation sensor
631 direction finder
640 detector
645 activated-color-channel signal
650 display control system
655 image data
660 display pixels
710 illumination system
712L left-eye light source
712LB left-eye colored light source
712LG left-eye colored light source
712LR left-eye colored light source
712R right-eye light source
712RB right-eye colored light source
712RG right-eye colored light source
712RR right-eye colored light source
720 monochrome reflective display system
728 display surface
740 detector
787 system controller

1. A stereoscopic display system for displaying a stereoscopic image having image data for a left-eye image channel and a right-eye image channel, comprising:
a) an illumination system including:
i) a left-eye light source providing light having a first optical property; and
ii) a right-eye light source providing light having a second optical property different from the first optical property; and
b) a monochrome reflective display system removably connectable to the illumination system, the monochrome reflective display system including:
i) a directly-viewable display surface including an array of display pixels, each having a respective controllable reflectance;
ii) a detector for automatically detecting whether or not the illumination system is connected to the display system and is powered and providing a corresponding connection signal; and
iii) a system controller that controls the display pixels and the illumination system in response to the connection signal, the display control system adapted to:
A) in response to the detector detecting that the illumination system is connected to the display system and is powered, sequentially activate the left-eye and right-eye light sources according to a temporal sequence, and control the reflectance of the display pixels in synchronization with the activation of the left-eye and right-eye light sources according to the image data for the left-eye image channel when the left-eye light source is activated and according to the image data for the right-eye image channel when the right-eye light source is activated; and
B) in response to the detector detecting that the illumination system is not connected to the display system or is not powered, determine monoscopic image data from the image data for the left-eye image channel or the image data for the right-eye image channel and control the reflectance of the display pixels according to the monoscopic image data.

2. The stereoscopic display system according to claim 1, wherein the first optical property is a first polarization state and the second optical property is a second polarization state.

3. The stereoscopic display system according to claim 1, wherein the first optical property is a first color and the second optical property is a second color.

4. The stereoscopic display system according to claim 1, wherein the first optical property is a first direction of incidence and the second optical property is a second direction of incidence.

5. The stereoscopic display system according to claim 4, wherein the display pixels have a reflection characteristic that is at least in part specular, and the system controller controls the display pixels so that light from the left-eye light source is specularly reflected to a selected left-eye position and light from the right-eye light source is specularly reflected to a selected right-eye position.

6. The stereoscopic display system according to claim 5, further including a control for receiving an indication of the spacing between the eyes of a viewer, wherein the system controller selects the left-eye position and the right-eye position according to the received indication.

7. The stereoscopic display system according to claim 1, wherein the illumination system includes a connector for selectively connecting to the monochrome reflective display system and a mounting bracket for mechanically connecting the connector to the colored light sources.

8. The stereoscopic display system according to claim 7, wherein the mounting bracket enables changing the orientation of the left-eye and right-eye light sources with respect to the monochrome reflective display system.

9. The stereoscopic display system according to claim 1, wherein the detector is further adapted to automatically detect an activated one of the left-eye and right-eye light sources providing illumination to the display surface, or that no illumination is being provided by the illumination system to the display surface, and to provide an activated-eye signal corresponding to the detected activated light source, and wherein the control of the reflectance of the display pixels by the system controller is further responsive to the activated-eye signal such that the reflectance of the display pixels is controlled according to the image data for the image channel corresponding to the activated one of the left-eye and right-eye light sources providing illumination to the display surface and according to the monoscopic image data in response to the detector detecting that no illumination is being provided by the illumination system to the display surface.

10. The stereoscopic display system according to claim 9, wherein the detector includes a light sensor for sensing light from the illumination system to detect the activated one of the left-eye and right-eye light sources.

11. The stereoscopic display system according to claim 9, wherein the detector includes a receiver adapted to receive an electrical, magnetic, or electromagnetic signal from a transmitter associated with the illumination system, the received signal providing an indication of the activated one of the left-eye and right-eye light sources, and wherein the detector provides the activated-eye signal in response to the received signal.

12. The stereoscopic display system according to claim 1 wherein the temporal sequence is a periodic temporal sequence.

13. The stereoscopic display system according to claim 1, wherein at least one of the left-eye and right-eye light sources includes a plurality of individual light emitting elements.

14. The stereoscopic display system according to claim 1 wherein the reflectance of the display pixels is controlled by controlling respective reflectivities of the display pixels.

15. The stereoscopic display system according to claim 1 wherein the reflectance of the display pixels is controlled by controlling respective reflectance directions of the display pixels.

16. The stereoscopic display system according to claim 1, wherein the illumination system includes a viewer interface that enables the user to turn on or off power to the illumination system.

17. A stereoscopic color display system for displaying a stereoscopic color image having image data for a plurality of left-eye image color channels and a plurality of right-eye image color channels, the system comprising:
a) an illumination system including:
i) a plurality of left-eye colored light sources, each providing light corresponding to an illumination color primary; and
ii) a plurality of right-eye colored light sources, each providing light corresponding to an illumination color primary; and
b) a monochrome reflective display system removably connectable to the illumination system, the display system including:
i) a directly-viewable display surface including an array of display pixels, each having a respective controllable reflectance;
ii) a detector for automatically detecting whether or not the illumination system is connected to the display system and is powered and providing a corresponding connection signal; and
iii) a system controller that controls the display pixels and the illumination system in response to the connection signal, the system controller being adapted to:
A) in response to the detector detecting that the illumination system is connected to the display system and is powered, sequentially activate the left-eye and right-eye colored light sources to sequentially provide a plurality of illumination channels corresponding to the left-eye and right-eye image color channels, so that each illumination channel defines a respective active eye and a respective active one of the illumination color channels, and control the reflectance of the display pixels according to the image data for each successive active eye and active one of the illumination color channels; and
B) in response to the detector detecting that the illumination system is not connected to the display system or is not powered, determine monoscopic, monochrome image data from the image data for one or more of the left-eye or right-eye image color channels and control the reflectance of the display pixels according to the monoscopic, monochrome image data so that the stereoscopic color display system functions as a monoscopic, monochrome display system.

18. The stereoscopic color display system according to claim 17, wherein each left-eye colored light source provides light having a first polarization state and each right-eye colored light source provides light having a second polarization state different from the first polarization state.

19. The stereoscopic color display system according to claim 17, further including a pair of shutter glasses including a left-eye shutter and a right-eye shutter, wherein the system controller controls the shutter glasses to open the left-eye shutter and close the right-eye shutter while the left eye is the active eye and controls the shutter glasses to open the right-eye shutter and close the left-eye shutter while the right eye is the active eye.

20. The stereoscopic color display system according to claim 17 wherein the illumination color primaries include red, green and blue primaries.

21. The stereoscopic color display system according to claim 17 wherein the illumination system provides each of the illumination color channels using exactly one respective illumination color primary of the illumination color primaries.

22. The stereoscopic color display system according to claim 17 wherein the illumination system provides at least one of the illumination color channels using a mixture of two or more of the illumination color primaries.

23. The stereoscopic color display system according to claim 17, wherein at least two of the provided illumination color channels have substantially the same color and have different luminances.

24. The stereoscopic color display system according to claim 17, wherein the illumination system includes a viewer interface that enables the user to turn power to the illumination system on or off.
